(19) United States
(12) Patent Application Publication
(10) Pub. No.: US 2016/0238858 A1
(43) Pub. Date: Aug. 18, 2016

(54) FLUID-FILLED EYEWEAR

(71) Applicant: Oceanus Investment Inc., Mahe (SC)

(72) Inventor: David CHAO, Saratoga, CA (US)

(21) Appl. No.: 14/857,359

(22) Filed: Sep. 17, 2015

(30) Foreign Application Priority Data
Feb. 17, 2015 (TW) 104202841

(51) Int. Cl. G02C 7/08; G02C 5/00

(52) U.S. Cl. CPC G02C 7/085; G02C 5/001

(57) ABSTRACT

A fluid-filled eyewear includes a frame body, a fluid-filled lens mounted on the frame body, and an optical poser adjusting device disposed within the frame body. The optical power adjusting device includes a reservoir for storing a fluid and disposed in fluid communication with the fluid-filled lens, and an actuation module. The actuation module includes a tilt sensor configured to sense a tilt angle of the frame body and to output a signal indicative of the tilt angle, an actuator operable to cause the fluid to flow between the reservoir and the fluid-filled lens, and a controller configured to receive the signal from the tilt sensor and to control operation of the actuator according to the tilt angle indicated by the signal.

### CROSS-REFERENCE TO RELATED APPLICATION

This application claims priority of Taiwanese Application No. 104202841, filed on Feb. 17, 2015.

### FIELD

The disclosure relates to a fluid-filled eyewear, more particularly to a fluid-filled eyewear capable of automatically adjusting optical power.

### BACKGROUND

Referring to FIG. 1, a conventional fluid-filled eyewear 1 has been disclosed and described in U.S. Pat. No. 8,488,250 B2. The conventional fluid-filled eyewear 1 includes a fluid-filled lens 11, a frame 12 having the fluid-filled lens 11 mounted thereon, a reservoir 13 disposed within the frame 12 for containing a fluid, and a power source 14 for providing an actuation signal (i.e., an electric potential) to the reservoir 13. The reservoir 13 is a tube disposed around a perimeter of the fluid-filled lens 11, and is made of a piezoelectric material. The reservoir 13 is in fluid communication with the fluid-filled lens 11. When the power source 14 applies the electric potential to the reservoir 13, the reservoir 13 flexes, causing the fluid to either inflate or deflate the fluid-filled lens 11 to change the optical power of the fluid-filled lens 11.

### SUMMARY

Therefore, an object of the disclosure is to provide a fluid-filled eyewear capable of automatically adjusting optical power.

According to the disclosure, the fluid-filled eyewear includes a frame body, at least one fluid-filled lens mounted on the frame body, and at least one optical power adjusting device disposed within the frame body. The optical power adjusting device includes a reservoir for storing a fluid and disposed in fluid communication with the at least one fluid-filled lens, and an actuation module. The actuation module includes a tilt sensor that is configured to sense a tilt angle of the frame body and to output a signal indicative of the tilt angle, an actuator that is operable to cause the fluid to flow between the reservoir and the at least one fluid-filled lens, and a controller that is configured to receive the signal from the tilt sensor and to control operation of the actuator according to the tilt, angle indicated by the signal.

### BRIEF DESCRIPTION OF THE DRAWINGS

Further features and advantages of the present disclosure will become apparent in the following detailed description of the embodiments with reference to the accompanying drawings, of which:

FIG. 1 is a perspective cut-away view illustrating a portion of a conventional fluid-filled eyewear disclosed in U.S. Pat. No. 8,488,250 B2;

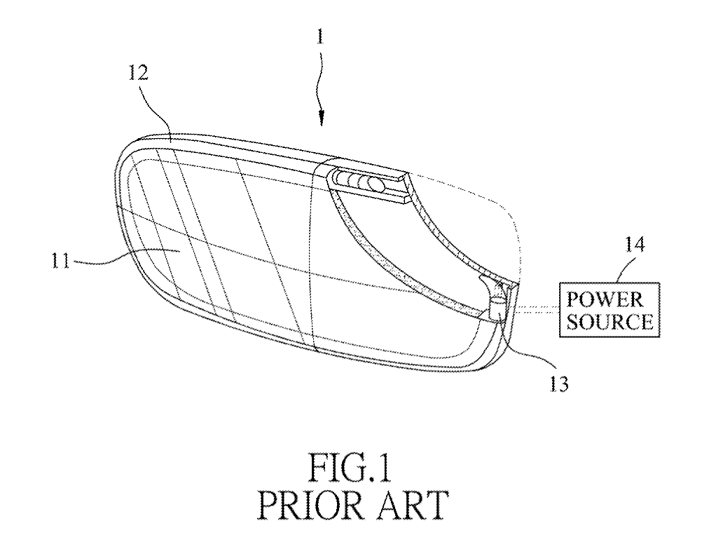

FIG. 2 is a perspective view of a first embodiment of a fluid-filled eyewear according to the disclosure;

FIG. 3 is a front view illustrating a tuba connecting a pair of fluid-filled lenses of the fluid-filled eyewear of the first embodiment;

FIG. 4 is a partially cross-sectional fragmentary view of the fluid-filled eyewear of the first embodiment, for illustrating an optical power adjusting device;

FIG. 5 is a side view of the fluid-filled eyewear for illustrating a tilt angle of a frame body; and

FIG. 6 is a partially cross-sectional fragmentary view of a second, embodiment of a fluid-filled eyewear according to the disclosure.

### DETAILED DESCRIPTION

Before the disclosure is described in further detail with reference to the accompanying embodiments, it should be noted herein that like elements are denoted, by the same reference numerals throughout the disclosure.

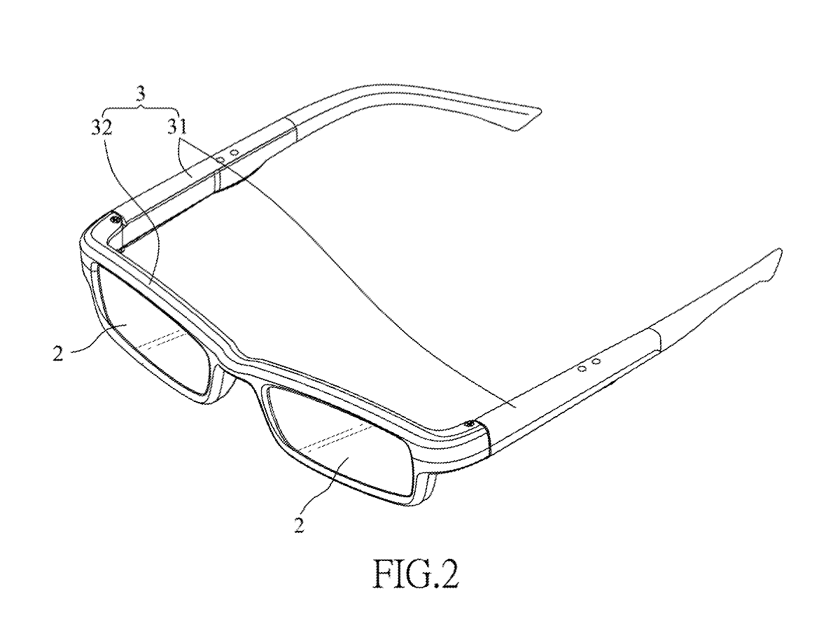

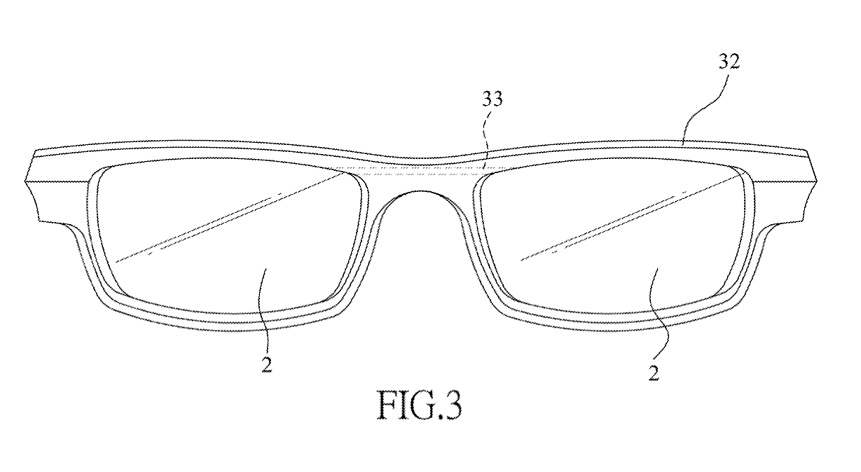

Referring to FIGS. 2 to 4, the first embodiment of the fluid-filled eyewear capable of automatically adjusting optical power according to the disclosure includes a pair of fluid-filled lenses 2, and an eyewear frame having the fluid-filled lenses 2 mounted thereon.

The eyewear frame includes a frame body 3 and an optical power adjusting device 4. For example, each of the fluid-filled lenses 2 is a myopic lens. Alternatively, each of the fluid-filled lenses 2 may be a hyperopic lens. In other embodiments, the fluid-filled eyewear according to this disclosure may include only one fluid-filled lens 2.

The frame body 3 has the fluid-filled lenses 21 mounted thereon, and includes a pair of temple pieces 31, a rim 32 having the fluid-filled lenses 2 mounted thereto, and a tube 33 connected between the fluid-filled lenses 2 and allowing fluid communication therebetween.

The optical power adjusting device 4 is disposed within one of the temple pieces 31 of the frame body 3, and is operable to adjust optical power of the fluid-filled lenses 2. It should be noted that, since operations of the optical power adjusting device 4 for adjusting the optical powers of the fluid-filled lenses 2 are substantially the same, the following description discusses the optical power adjusting device 4 with respect to only one of the fluid-filled lenses 2 for the sake of brevity. Certainly, in other embodiments, the fluid-filled eyewear may include a pair of the optical power adjusting devices 4 for adjusting the optical powers of the fluid-filled lenses 2, respectively, and the tube 33 can be omitted.

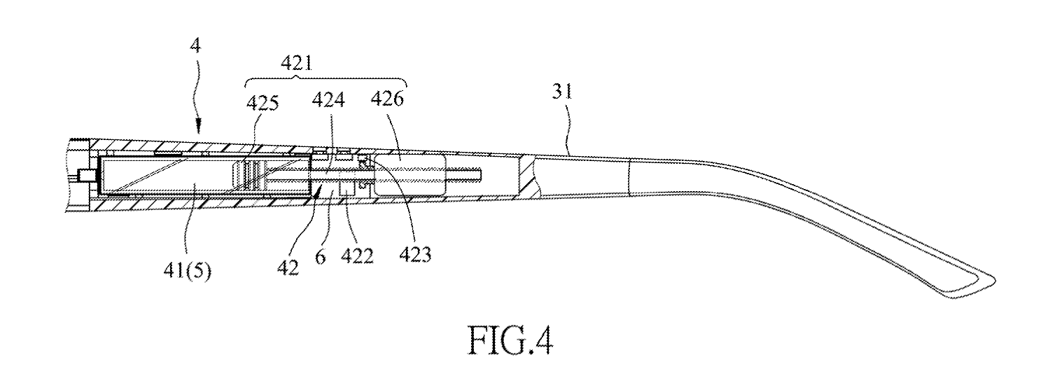

The optical power adjusting device 4 includes a reservoir 41 and an actuation module 42. The reservoir 41 stores a fluid 5, and is in fluid communication with the fluid-filled lens 2. The actuation module 42 includes an actuator 421, a controller 422 and a tilt sensor 423. The actuator 421 includes a piston 425 disposed fittingly and movably in the reservoir 41, a connecting rod 424 connected to the piston 425, and a motor 426 meshed with the connecting rod 424 for driving the connecting rod 424 to move the piston 425 in the reservoir 41, causing the fluid 5 to flow between the reservoir 41 and the fluid-filled lens 2. The tilt sensor 423 is one of a gyroscope, an accelerometer and a level gauge. As shown in FIG. 4, the controller 422, the tilt sensor 423 and the motor 426 of the actuator 421 are electrically connected to a printed circuit. board. In other embodiments, the tilt sensor 423 may be disposed at the rim 32.

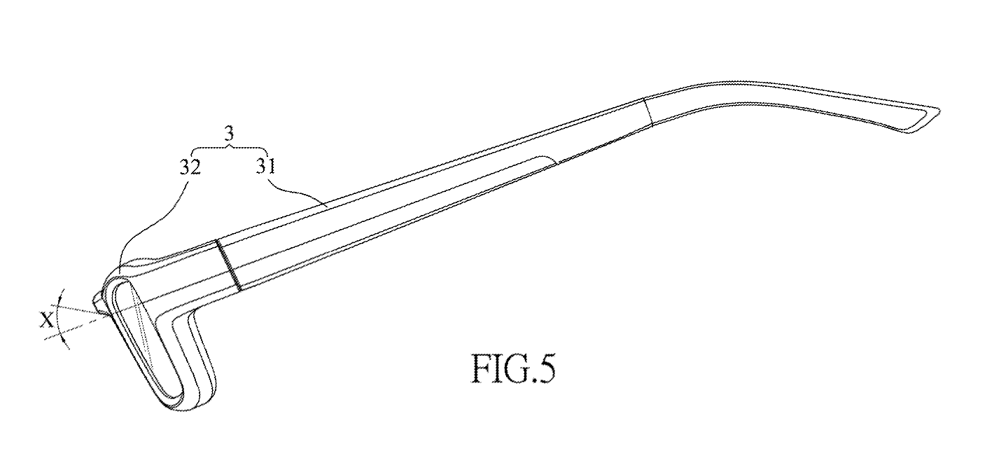

Further referring to FIG. 5, in operation, the tilt sensor 423 is operable to sense a tilt angle (X) of the frame body 3 with respect to a reference line (e.g., the ground level), and to output a signal indicative of the tilt angle (X). The tilt angle (X) of the frame body 3 can be used as reference information for determining whether a wearer of the fluid-filled eyewear is reading. For example, when the wearer bows his/her head and reads an article, the tilt angle (X) should be greater than a tilt angle of the frame body 3 in the case where the wearer's viewing angle is horizontal.

The controller 422 is configured to receive the signal from the tilt sensor 423, and to control operation of the actuator 421 according to the tilt angle (X) indicated by the signal. The controller 422 stores a threshold angle value, a first threshold time length and a second threshold time length. In particular, the controller 422 is programmed to actuate the actuator 421 for causing the fluid 5 to flow into or out from the fluid-filled lens 2 when the tilt angle (X) is greater than the threshold angle value. In this embodiment, once a duration in which the tilt angle (X) is greater than the threshold angle value reaches the first threshold time length, the controller 422 is programmed to control the actuator 421 to cause the fluid 5 to flow between the reservoir 41 and the fluid-filled lens 2, rendering optical power of the fluid-filled lens 2 equal to a first diopter value. Further, once a period equal to the second threshold time length has elapsed after the duration reaches the first threshold time length, the controller 422 is programmed to control the actuator 421 to cause the fluid 5 to flow between the reservoir 41 and the fluid-filled lens 2, rendering the optical power of the fluid-filled lens 2 equal to a second diopter value smaller than the first diopter value. The second diopter value may be a default diopter value of the fluid-filled lens 2 in accordance with the degree of myopia of the wearer, or a different diopter value that is smaller than the first diopter value for different requirements.

For example, for a fluid-filled lens 2 with a default diopter value less than +2.0 diopters, in order to decrease progression of myopia, the first threshold time length is 20 minutes, the second threshold time length is 20 seconds, the threshold angle value is 15 degrees, and the first diopter value is 42.0 diopters. When the wearer bows his/her head for reading, the tilt angle (X) of the frame body 3 is greater than the threshold angle value. Once the tilt angle (X) is greater than the threshold angle value, the controller 422 is programmed to start timing the duration in which the tilt angle (X) continues to be greater than the threshold angle value. When the duration reaches 20 minutes (i.e., the first threshold time length), the controller 422 controls the actuator 421 to cause the fluid 5 to flow out from the fluid-filled lens 2, increasing the optical, power of the fluid-filled lens 2 from the default diopter value to the first diopter value (i.e., +2.0 diopters). The increase in the optical power of the fluid-filled lens 2 may remind the wearer to stop reading for a while and to take a break by looking at a distant view 20 feet away. The controller 422 re-starts timing once the duration reaches the first threshold time length and the optical power of the fluid-filled lens 2 is adjusted to the first diopter value, and controls the actuator 421 to cause the fluid 5 to flow into the fluid-filled lens 2 once a period equal to the second threshold time length (i.e., 20 seconds) has elapsed. As a result, the optical power of the fluid-filled lens 2 is reduced to the second diopter value.

In other embodiments, the second threshold time length may be greater than the first threshold time length. For example, the first threshold time length is 20 minutes, and the second threshold time length is 20 minutes and 20 seconds. The controller 422 is programmed to start counting a time period once the tilt angle (X) is greater than the threshold angle value. If the tilt angle (X) continues to be greater than the threshold angle value for a duration that equals the first threshold time length from the beginning of the counting of the time period, the controller 422 is programmed to control the actuator 421 to cause the fluid 5 to flow out of the fluid-filled lens 2, rendering the optical power of the fluid-filled lens 2 equal to the first diopter value. Meanwhile, the controller 422 continues counting the time period, and upon the time period reaching the second threshold time length (i.e., 2′20″), controls the actuator 421 to cause the fluid 5 to flow from the reservoir 41 into the fluid-filled lens 2, rendering the optical power of the fluid-filled lens 2 equal, to the second diopter value,

It should be noted that the controller 422 can be programmed by connecting the controller 422 to a computer through a transmission cable or wireless communication. The computer can be installed with a specific program interface for programming the controller 422. Alternatively, a mobile device, such as a smart phone or a tablet computer, can communicate with the controller 422 through Bluetooth©, and can be installed with an application for programming the controller 422.

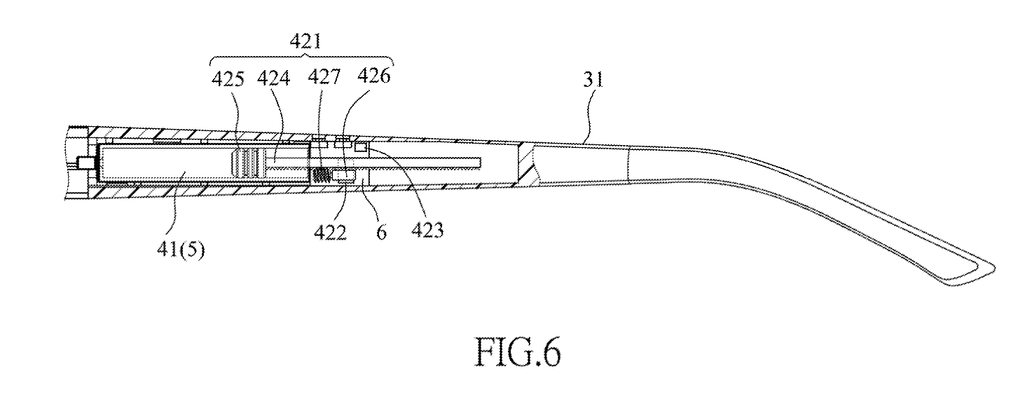

Referring to FIG. 6, the second embodiment of the fluid-filled eyewear according to the disclosure is similar to the first embodiment. In the second embodiment, the actuator 421 further includes a screw gear 427 connected to the motor 426 and meshed with the connecting rod 424 for driving the connecting rod 424.

In sum, by virtue of the tilt sensor 423, the controller 422 is operable to control operation of the actuator 421 according to the tilt angle (X) indicated by the signal from the tilt sensor 423. Accordingly, the fluid-filled eyewear according to the disclosure is capable of automatically adjusting the optical power of the fluid-filled lens 2.

While the disclosure has been described in connection with what are considered the exemplary embodiments, it is understood that this disclosure is not limited to the disclosed embodiments but is intended to cover various arrangements included within the spirit and scope of the broadest interpretation so as to encompass ail such modifications and equivalent arrangements.

What is claimed is:

1. A fluid-filled eyewear comprising:
a frame body;
at least one fluid-filled lens mounted on said frame body; and
at least one optical power adjusting device disposed within said frame body, and including
a reservoir for storing a fluid and disposed in fluid communication with said at least one fluid-filled lens, and
an actuation module including a tilt sensor that is configured to sense a tilt angle of said frame body and to output a signal indicative of the tilt angle, an actuator that is operable to cause the fluid to flow between said reservoir and said at least one fluid-filled lens, and a controller that is configured to receive the signal from said tilt sensor and to control operation of said actuator according to the tilt angle indicated by the signal.

2. The fluid-filled eyewear as claimed in claim 1, wherein said controller stores a threshold angle value, and is configured to actuate said actuator when the tilt angle is greater than the threshold angle value.

3. The fluid-filled eyewear as claimed in claim 2, wherein said controller further stores a first threshold time length,
wherein, once a duration in which the tilt angle is greater than the threshold angle value reaches the first threshold time length, said controller is further configured to control said actuator to cause the fluid to flow between said reservoir and said at least one fluid-filled lens, rendering optical power of said at least one fluid-filled lens equal to a first diopter value.

4. The fluid-filled eyewear as claimed in claim 3, wherein said controller further stores a second threshold time length,
wherein, once a period equal to the second threshold time length has elapsed, after the duration reaches the first threshold time length, said controller is further configured to control said actuator to cause the fluid to flow between said reservoir and said at least one fluid-filled lens, rendering the optical power of said at least one fluid-filled lens equal a second diopter value different from the first diopter value.

5. The fluid-filled eyewear as claimed in claim 2, wherein said controller further stores a first threshold time length and a second threshold time length greater than the first threshold time length, and is configured to:
start counting a time period once the tilt angle is greater than the threshold angle value; and
if the tilt angle continues to be greater than the threshold angle value for a duration that equals the first threshold time length from the beginning of the counting of the time period,
control said actuator to cause the fluid to flow between said reservoir and said at least one fluid-filled lens, rendering optical power of said at least one fluid-filled lens equal to a first diopter value, and
upon the time period reaching the second threshold time length, control said actuator to cause the fluid to flow between said reservoir and said at least one fluid-filled lens, rendering the optical power of said at least one fluid-filled lens equal to a second diopter value different from the first diopter value.

6. The eyewear as claimed in claim 1, comprising a pair of said fluid-filled lenses,
wherein said frame body includes a tube connected between said fluid-filled lenses and allowing fluid communication therebetween.

7. The eyewear as claimed in claim 1, comprising a pair of said fluid-filled lenses, and a pair of said optical power adjusting devices corresponding to said fluid-filled lenses, respectively.

8. The fluid-filled eyewear as claimed in claim 1, wherein said actuator includes a piston disposed fittingly and movably in said reservoir, a connecting rod connected to said piston, and a motor meshed with said connecting rod for driving said connecting rod to move said piston in said reservoir, causing the fluid to flow between said reservoir and said at least one fluid-filled lens.

9. The fluid-filled eyewear as claimed in claim 1, wherein said tilt sensor is one of a gyroscope, an accelerometer and a level gauge.

10. An eyewear frame configured to have a fluid-filled lens mounted thereon, said eyewear frame comprising:
a frame body for mounting of the fluid-filled lens; and
at least one optical power adjusting device disposed within said frame body, and including
a reservoir for storing a fluid and configured to be in fluid communication with the fluid-filled lens, and
an actuation module including a tilt sensor that is configured to sense a tilt angle of said frame body and to output a signal indicative of the tilt angle, an actuator that is operable to cause the fluid to flow between said reservoir and the fluid-filled lens, and a controller that is configured to receive the signal from said tilt sensor and to control operation of said actuator according to the tilt angle indicated by the signal.

11. The eyewear frame as claimed in claim 10, wherein said controller stores a threshold angle value, and is configured to actuate said actuator when the tilt angle is greater than the threshold angle value.

12. The eyewear frame as claimed in claim 11, wherein said controller further stores a first threshold time length,
wherein, once a duration in which the tilt angle is greater than the threshold angle value reaches the first threshold time length, said controller is further configured to control said actuator to cause the fluid to flow between said reservoir and the fluid-filled lens, rendering optical power of the fluid-filled lens equal to a first diopter value.

13. The eyewear frame as claimed in claim 12, wherein said controller further stores a second threshold time length,
wherein, once a period equal to the second threshold time length has elapsed after the first duration reaches the first threshold time length, said controller is further configured to control said actuator to cause the fluid to flow between said reservoir and the fluid-filled lens, rendering the optical power of the fluid-filled lens equal to a second diopter value different from the first diopter value.

14. The eyewear frame as claimed in claim 11, wherein said controller further stores a first threshold time length and a second threshold time length greater than the first threshold time length, and is configured to:
start counting a time period once the tilt angle is greater than the threshold angle value; and
if the tilt angle continues to be greater than the threshold angle value for a duration that equals the first threshold time length from the beginning of the counting of the time period,
control said, actuator to cause the fluid to flow between said reservoir and the fluid-filled lens, rendering optical power of the fluid-filled lens equal to a first diopter value, and
upon the time period reaching the second, threshold time length, control said actuator to cause the fluid to flow between said reservoir and the fluid-filled lens, rendering the optical power of the fluid-filled lens equal to a second diopter value different from the first diopter value.

15. The eyewear frame as claimed in claim 10, wherein said frame body is configured for mounting of a pair of the fluid-filled lenses, and includes a tube configured to be connected between the fluid-filled lenses and allowing fluid communication therebetween.

16. The eyewear frame as claimed in claim 10, wherein said frame body is configured for mounting of a pair of the fluid-filled lenses, and said eyewear frame comprises a pair of said optical power adjusting devices corresponding to the fluid-filled lenses, respectively.

17. The eyewear frame as claimed in claim 10, wherein said actuator includes a piston disposed fittingly and movably in said reservoir, a connecting rod connected to said piston, and a motor meshed with said connecting rod for driving said connecting rod to move said piston in said reservoir, causing the fluid to flow between said reservoir and the fluid-filled lens.

18. The eyewear frame as claimed in claim 10, wherein said tilt sensor is one of a gyroscope, an accelerometer and a level gauge.
